(19) United States
(12) Patent Application Publication
(10) Pub. No.: US 2008/0030922 A1
(43) Pub. Date: Feb. 7, 2008

(54) Multi-Layer Capacitor and Mold Capacitor

(75) Inventors: Akio Hidaka, Miyazaki (JP); Yuuichi Murano, Miyazaki (JP); Shinichi Wakasugi, Miyazaki (JP); Hidetsugu Fujimoto, Miyazaki (JP); Yoshitaka Mizoguchi, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/575,656

(22) PCT Filed: Sep. 27, 2005
(86) PCT No.: PCT/JP05/18256

§ 371 Date: Mar. 21, 2007

(30) Foreign Application Priority Data
Sep. 27, 2004 (JP) 2004-279070
Sep. 28, 2004 (JP) 2004-281829

(51) Int. Cl. H01G 4/38

(52) U.S. Cl. 361/303

(57) ABSTRACT

A mulitilayer A capacitor includes a plurality of dielectric substrates (2) which are layered; a pair of terminal electrodes formed on the plurality of dielectric substrates; a plurality of internal electrodes (3) arranged on each of the dielectric substrates and having outer edges (30) opposed apart by a predetermined interval, wherein at least one of the internal electrodes (3) is arranged apart from the adjacent internal electrode (3) by the maximum interval (5) at the center of the outer edges (30).

### TECHNICAL FIELD

This invention relates to a multi-layered capacitor and mold capacitor which are preferably applied to electronic devices such as a modem, a power source circuit, a power source of liquid crystal devices, a DC-DC converter and a power line communication device.

### BACKGROUND ART

In the electronic device such as the modem and power circuit, a large number of electronic components are mounted. For example, in many cases, capacitors for noise elimination and DC component cutting are employed.

Meanwhile, the electronic device requires down-sizing and cost reduction and hence the electronic components also require remarkable down-sizing and cost reduction. Further, for reduction of mounting cost and mounting area by automated mounting, face-mounted electronic components are often required. On the other hand, contradictive specifications such as high performance, reduced characteristic fluctuation and improved endurance as well as cost reduction are often demanded.

Particularly, the capacitors are often employed in the power source circuit and for noise elimination in a plasma display or large-scale liquid crystal display. Therefore, implementation of high capacitance and high withstand voltage of the capacitors is demanded.

In order to realize such high capacitance, a multilayer capacitor in which a large number of dielectric substrates each with internal electrodes are layered is often employed (for example, JP-A-2001-284157).

In order to assure higher capacitance and higher withstand voltage, a structure has also been proposed in which on the same dielectric substrate, a plurality of internal electrodes are layered in a vertically staggered configuration so that a plurality of capacitor components are connected in series.

FIG. 20 is a side sectional view of a mulitilayer capacitor consisting of a plurality of dielectric substrates for layering according to a prior art.

In FIG. 20, reference numeral 100 denotes a multilayer capacitor; 102 a dielectric substrate; 102 an internal electrode; 103 a terminal electrode; and 104 an interval between adjacent internal electrodes.

The multilayer capacitor 100 is formed by layering a plurality of dielectric substrates 101. The dielectric substrate 101 has the internal electrode 102 formed by screen printing, transfer-printing or paste application. Namely, the dielectric substrates 101 each with internal electrodes formed on the surface are layered so that capacitor components are created between the internal electrodes 102, i.e the layers thereof formed on the different dielectric substrates 101. These capacitor components are summed thereby realizing the high capacitance as a whole.

However, at present, in addition to the high capacitance by the mulitilayer capacitor, the high withstand voltage thereof is also demanded.

When a voltage is applied to the multilayer capacitor, the strongest voltage stress is applied to the vicinity of the center of the multilayer capacitor. Therefore in order to improve the withstand voltage of the multilayer capacitor, the withstand voltage must be improved at the vicinity of the center of the multilayer capacitor. The region susceptible to the voltage stress is the region where the internal electrodes formed on the same dielectric substrate surface are adjacent to each other. Further, among the regions where the internal electrodes 102 are adjacent, the stress is concentrated at the center rather than the ends. Thus, stress concentration at the center (center in the width direction of the dielectric substrate) of the regions where the internal electrodes are adjacent is most problematic.

In the multilayer capacitor consisting of the dielectric substrates 101 according to the prior art, the region where the plurality of internal electrodes 102 formed on the single dielectric substrate 101 are formed in a linear shape so that the interval 104 between the adjacent internal electrodes is approximately uniform. This presented a problem that the level in the withstand voltage corresponding to the voltage stress differs between the center to which more stress is concentrated and the end.

Owing to the different levels in the withstand voltage, according to the regions of the dielectric substrate 101, the voltage stress does not appropriately correspond to the withstand voltage.

Owing to the voltage stresses different according to the regions and the withstand voltages not in balance therewith, eventually, the dielectric substrates 101 and the multilayer capacitor using these dielectric substrates 101 have an insufficient withstand voltage.

Specifically, although the level of the voltage stress differs at the positions of the dielectric substrate, and hence those of the multilayer capacitor 100, the withstand voltage is uniform at any position. As a result, the entire structure of the multilayer capacitor does not have the structure optimized for the withstand voltage.

As a result, the withstand voltage of the multilayer capacitor could not be surely improved. This was a significant problem in the cases where the downsizing of devices is demanded.

### DISCLOSURE OF INVENTION

This invention has been accomplished in order to attain the above problem. An object of this invention is to provide a multilayer capacitor and mold capacitor which can realize a high withstand voltage without hindering downsizing and implementation of high capacitance.

In order to attain the above object, in accordance with this invention, there is provided a mulitilayer capacitor comprising: a plurality of dielectric substrates which are layered; a pair of terminal electrodes formed on the plurality of dielectric substrates; a plurality of internal electrodes arranged on each of the dielectric substrates and having outer edges opposed apart by a predetermined interval, wherein at least one of the internal electrodes is arranged apart from the adjacent internal electrode by the maximum interval at the center of the outer edges.

### BRIEF DESCRIPTION OF DRAWINGS

FIGS. 1, 2, 3, 4, 5 and 6 are a top view of a dielectric substrate for layering according to the first embodiment of this invention, respectively;

FIG. 7 is a side sectional view of a multilayer capacitor according to this embodiment;

FIG. 8 is a side sectional view of a mold capacitor according to this embodiment;

FIG. 9 is an entire perspective view of the mold capacitor according to this embodiment;

FIG. 10 is a graph showing the relationship between the serge breakdown voltage and capacitance in the multilayer capacitor according to this invention;

FIGS. 11 to 19 are a side view of the multilayer capacitor according to the second embodiment of this invention, respectively; and

FIGS. 20 and 21 are side sectional views of a multilayer capacitor according to the conventional art.

### BEST MODE FOR CARRYING OUT THE INVENTION

Now referring to the drawings, an explanation will be given of various embodiments of this invention.

### Embodiment 1

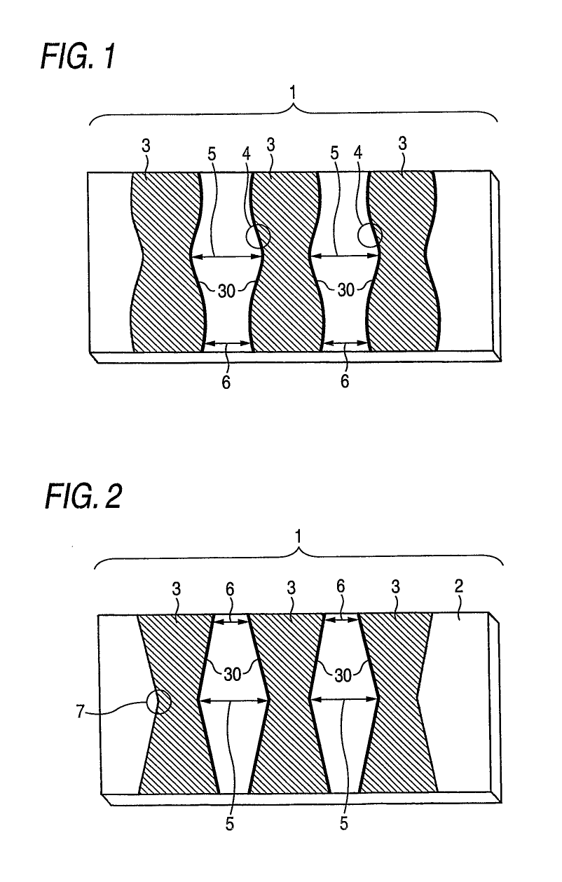

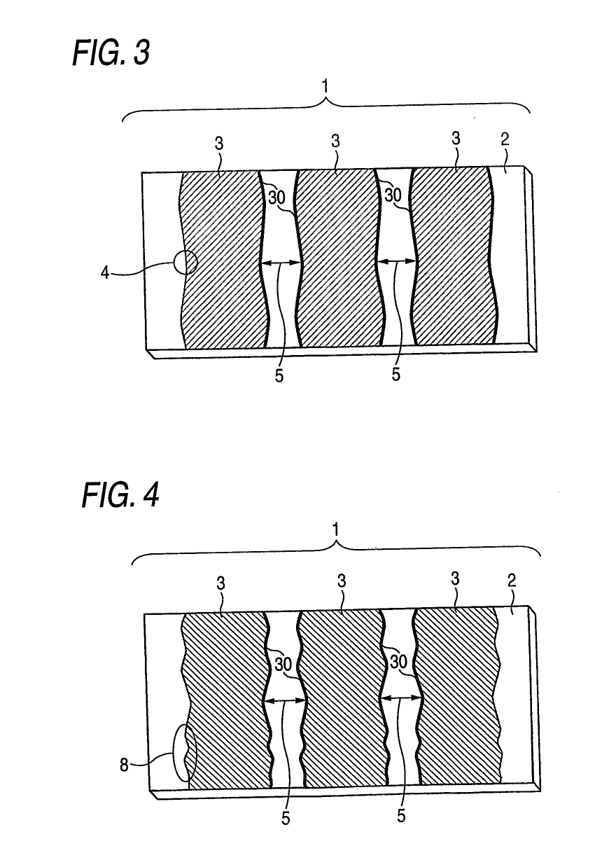

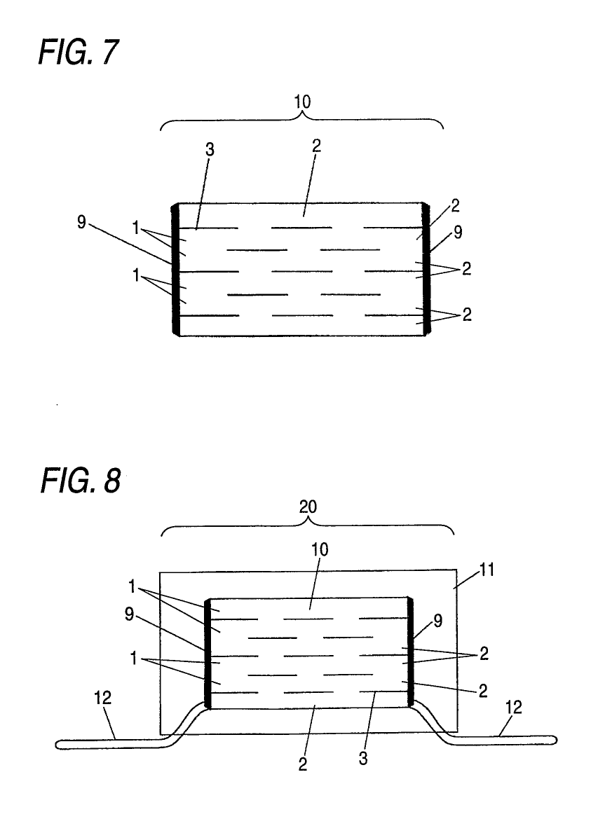

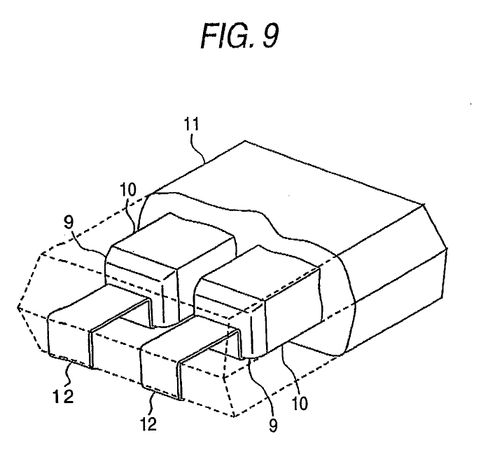

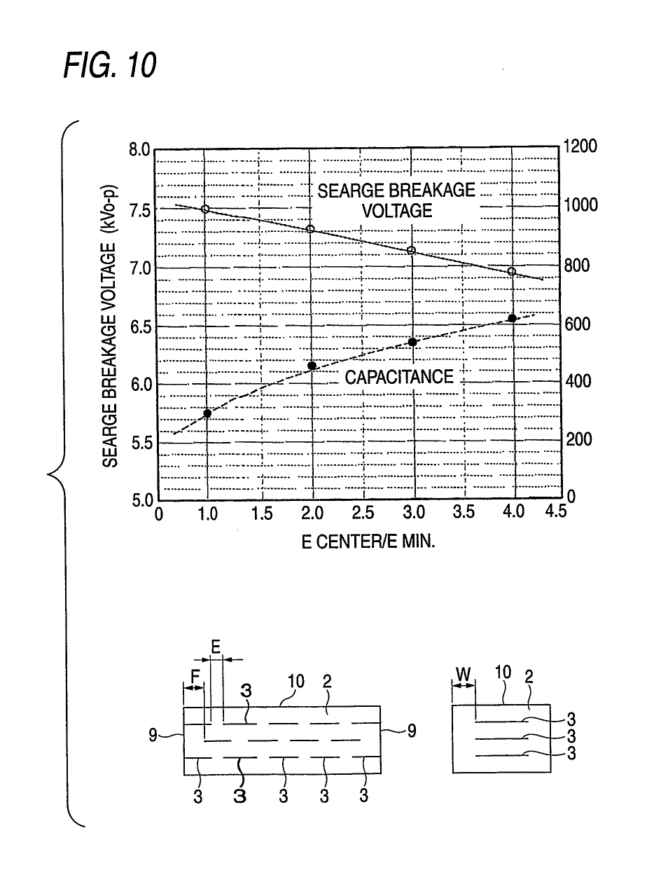

FIGS. 1, 2, 3, 4, 5 and 6 are a top view of a dielectric substrate for layering according to the first embodiment of this invention, respectively. FIG. 7 is a side sectional view of a multilayer capacitor according to this embodiment. FIG. 8 is a side sectional view of a mold capacitor according to this embodiment. FIG. 9 is an entire perspective view of the mold capacitor according to this embodiment. FIG. 10 is a graph showing the relationship between the serge breakdown voltage and capacitance in the multilayer capacitor according to this invention.

In these figures, reference numeral 1 denotes a layered dielectric substrate; 2 a dielectric substrate; 3 an internal electrode; 4 a constriction; 5 a maximum interval zone; 6 a minimum interval zone; 7 a dent; 8 a wavy area; 9 a terminal electrode; 10 a mulitilayer capacitor; 11 a package; 12 a lead terminal; and 20 a mold capacitor.

First, a detailed explanation will be given of each component.

First, the dielectric substrate 1 for layering will be explained.

The dielectric substrate 1 for layering is a dielectric substrate which serves as a minimum unit for laying constituting the multilayer capacitor 10. A plurality of dielectric layers 1 stacked constitutes the multilayer capacitor 10.

Next, the dielectric substrate 2 will be explained.

The dielectric substrate 2 is a substrate of a dielectric material, which is preferably e.g. titanium oxide or barium titanate. The dielectric material may be alumina. According to the desired dielectric constant (the value of capacitance can be adjusted by the dielectric constant) and material strength of these oxide-series dielectric material, metallic dielectric material and ceramic-series dielectric material, the material and its composition ratio are selected appropriately.

Further, these materials are mixed with an organic material, as required, to be molded into any shape, and heat-treated, as required, to be formed into a substrate shape.

The dielectric substrate 2 is formed in a size and shape corresponding to those of the multilayer capacitor 10. For example, the dielectric substrate 2 may be formed of a rectangular plate having a desired thickness, a film-like sheet or the plate in the other shape than the rectangle. In order to improve the endurance, the corners of the dielectric substrate 2 may be chamfered. Particularly, if the corners of each of the dielectric substrates 2 are chamfered in their layering, the dielectric substrates 2 is prevented from breaking or damaging in manufacturing, transporting and packaging. Thus, the dielectric substrates are improved shock endurance.

The dielectric substrates 2 may have different thicknesses even when a single multilayer capacitor is formed. For example, the dielectric substrate(s) 2 layered in the vicinity of the center may have a larger thickness whereas the dielectric substrate(s) in the other region may have a smaller thickness. By adopting such a structure, the withstand voltage in the vicinity of the center to which stronger voltage stress is applied can be improved.

By layering the dielectric substrates having different thicknesses changed gradually according to the regions where the voltage stress is increased, the balance between the voltage stress and withstand voltage can be preferably optimized.

Next, the internal electrode 3 will be explained.

The internal electrode 3 is an electrode plane formed on the dielectric substrate 2. The internal electrode 3 is formed on the surface of each plate-like dielectric substrate 2 which is a unit for layering. The internal electrode 3 may be made of the metallic material or alloy containing at least one of Ni, Ag, Pd, Cu and Au. Particularly, using elemental Ni or Ni alloy is preferable from the viewpoint of cost. Further, the internal electrode 3 may be plated on the surface. The thickness of the internal electrode 3 is preferably 1 to 5 μm This is because if the thickness is smaller than 1 μm, a sufficient withstand voltage cannot be kept whereas if the thickness is larger than 5 μm, the fixing force between the dielectric substrates 3 when they are layered becomes insufficient or gap therebetween becomes too large, thus making the layering strength insufficient.

The internal electrode 3 may be formed by transfer-printing the electrode plane of the above-mentioned metallic material formed on a transfer body onto the surface of the dielectric substrate 2. In the transfer-printing, a surface of the dielectric substrate 2 is damaged with less possibility and the internal electrode 3 will be embedded in the dielectric substrate 2. This gives a merit of not presenting a problem that the surface becomes uneven and any gap is created after layering.

Otherwise, a metallic paste may be directly applied to a surface of the dielectric substrate 2. Further, vapor deposition or plating may be adopted.

The internal electrode 3 may be formed on the dielectric substrate 2 surface by screen printing. The required specifications relative to the accuracy of the shape, area and thickness of the internal electrode 3 and the endurance thereof may be determined on the basis of the affinity between the material of the dielectric substrate 2 and internal electrode 3.

As shown in FIGS. 1 and 2, the internal electrode 3 is preferably in plurality on the surface of a single dielectric substrate 2. Further, as shown in FIG. 7, the internal electrodes 3 are preferably arranged so as to overlap partially at staggered positions according to the positions where the dielectric substrates 2 are layered. Thus, capacitors are created between the internal electrodes 3 which overlap alternately so that a large number of portions providing the capacitor components within the multilayer capacitor 10 are created, thereby realizing a high capacitance.

In FIG. 1, a plurality of internal electrodes 3 are arranged on the dielectric substrate 2. Now, three internal electrodes 3 are opposed to be apart by a prescribed interval. The number of the internal electrodes 3 should not be limited to three, but may be any number. As shown in FIG. 1, each internal electrode 3 has a constricted shape, and has an outer edge 30 opposite to the adjacent internal electrode 3. The outer edges 30 are illustrated in bold line for the sake of convenience in order to facilitate the understanding of the invention. The internal electrode 3 is apart from the adjacent internal electrode 3 by a maximum interval at the center of the outer edges. This applies to the internal electrodes 3 explained later in connection with FIGS. 2 to 6.

Now as shown in FIG. 1, the interval between the internal electrodes 3 is preferably nonuniform. The “non-uniform” means that the interval between the adjacent internal electrodes 3 is not constant over the adjacent outer edges 30 and provides both maximum and minimum interval zones therebetween. The non-uniform interval can be realized by the linear, curved, arc or wavy shape of the outer edge of the internal electrode 3.

As described above, it is preferred that the interval between the adjacent internal electrodes is non-uniform to provide the maximum interval zone 5 and minimum interval zone 6.

Preferably, the maximum interval zone 5 is formed in the vicinity of the center in the lateral direction of the dielectric substrate 2, i.e. in the direction perpendicular to the longitudinal direction in which the internal electrodes 3 are adjacent, whereas the minimum interval zone 6 is formed in the vicinity of the ends in the same direction. Thus, in the vicinity of the center in the lateral direction where the greatest voltage stress is applied, the interval between the adjacent internal electrodes 3 is larger so that the withstand voltage can be improved. Further, in the vicinity of the ends in the lateral direction, the minimum interval zone 6 is formed between the adjacent internal electrodes 3 and the smaller voltage stress is applied to this area. Thus, the internal electrodes 3 can be arranged with optimized balance between the interval and the applied voltage stress.

The non-uniform interval between the adjacent internal electrodes 3 may also be realized by a constriction 4 and dent 7 rather than the non-linear shape of the outer edge.

The constriction 4 and dent 7 will be explained below.

In FIG. 1, the constriction 4 is illustrated. The constriction 4 is formed on the internal electrode 3, and has an arc, linear, wavy or concave shape.

By forming the constriction 4 on each internal electrode 3, the interval between the adjacent internal electrodes 3 can be made non-uniform. Particularly, by making the constrictions 3 opposite to each other, the maximum interval zones 5 between the adjacent internal electrodes 3 as shown in FIG. 1 can be formed. Further, by making the constrictions 3 opposite to each other, the areas other than the constrictions 3 are also opposite and hence the minimum interval zones 6 can be formed. Particularly, by forming the constrictions 4 in the vicinity of the center in the lateral direction of the dielectric substrate 2, the maximum interval zones 5 are formed in the vicinity of the center in the lateral direction and the minimum interval zones 6 are formed in the vicinity of the ends in the lateral direction. Thus, the internal electrodes 3 with optimized balance between the voltage stress and withstand voltage can be formed.

Accordingly, the plurality of internal electrodes 3 formed on the dielectric substrate 2 can be arranged with a good balance between the interval between the adjacent electrodes and the voltage stress, thereby improving the withstand voltage.

This applies the case where the dents 7 are formed as shown in FIG. 7. By forming the dent 7 on each internal electrode 3, the interval between the adjacent internal electrodes 3 is non-uniform. The maximum interval zone 5 and minimum interval zone 6 are formed between the adjacent internal electrodes 3.

In this case, by making the dents 7 of the adjacent internal electrodes 3 opposite to each other, the maximum interval zones 5 can be formed. Particularly, as shown in FIG. 2, by arranging the innermost parts of the dents 7 at the center in the lateral direction of the dielectric substrate 2, the withstand voltage at the areas where the greatest voltage stress is applied can be improved. Thus, the withstand voltage in balance with the voltage stress can be realized. Hence, the dielectric substrate 1 capable of providing the multilayer capacitor 10 with an optimized withstand voltage can be realized.

Of course, as shown in FIG. 4, the interval between the adjacent internal electrodes may be made non-uniform by wavy areas 8. By arranging the wavy areas 8 at the center in the lateral direction of the dielectric substrate 2 to provide the maximum interval zone 5, the balance between the voltage stress and the withstand voltage can be optimized.

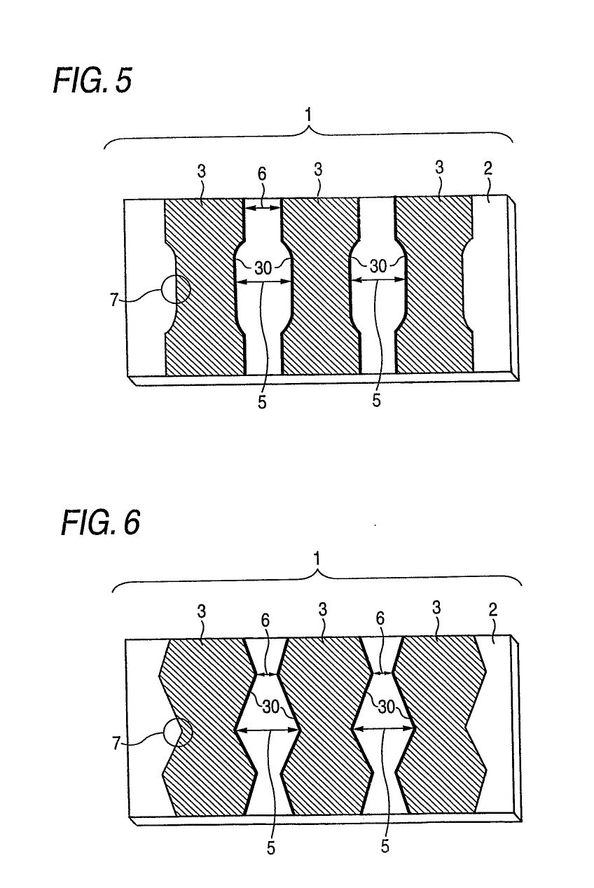

Otherwise, as shown in FIG. 5, arc-shaped dents 7 providing the maximum interval zone 5 in the vicinity of the center may be formed.

Otherwise, as shown in FIG. 6, by arranging the internal electrodes 3 formed in a polygon exceeding a pentagon so that the dents are opposite to each other, the maximum interval zones 5 and minimum interval zones 6 can be provided. In this case, by forming the maximum interval zones 5 in the vicinity of the center in the lateral direction of the dielectric substrate 2, the balance between the voltage stress and the withstand voltage can be optimized.

Now, the voltage stress means the stress created within the device by the voltage applied to the terminals when the layered dielectric substrates 1 are layered to form the multilayer capacitor 10. As a matter of course, this voltage stress is concentrated at a position nearer to the center.

The voltage stress is the greatest in the vicinity of the respective centers in the longitudinal direction (internal electrodes 3 are arranged) of the multilayer capacitor 10, in the height direction thereof, and in the lateral direction (perpendicular to the longitudinal direction). The device will be broken or damaged by the voltage stress in the region where internal electrodes 3 are adjacent to each other, or opposite to each other when they are layered. As regards the voltage stress in the lateral direction of the multilayer capacitor 10, the withstand voltage in the region where the plurality of internal electrodes 3 formed on the single dielectric substrate 2 are adjacent is problematic. In order to obviate such a problem, as described above, the interval between the adjacent internal electrodes 3 is made non-uniform and the maximum interval zones 5 and minimum interval zones 6 are made by the dents 7 or constrictions 4 so that the maximum interval 5 is located in the vicinity of the center where the greatest voltage stress is applied. In this configuration, the withstand voltage can be improved. Particularly, by arranging the minimum interval zones 6 in the vicinity of the ends in the lateral direction, the balance between the voltage stress and withstand voltage can be optimized, thereby improving the withstand voltage for the voltage stress in the lateral direction.

Next, an explanation will be given of the multilayer capacitor 10 using these layered dielectric substrates 1.

FIG. 7 shows the multilayer capacitor 10 including a plurality of layered dielectric substrates 1 and a pair of terminal electrodes 9. The terminal electrodes 9 serve to supply a current to a part of the internal electrodes 3. The pair of terminal electrodes 9 may be provided on both ends as shown in FIG. 7, but may be provided on the upper and lower sides. The pair of terminal electrodes may be provided according to the shape of the mulitilayer capacitor 10.

The terminal electrode 9, like the internal electrode 3, may be made of the metallic material or alloy containing at least one of Ni, Ag, Pd, Cu and Au. Particularly, using elemental Ni or Ni alloy is preferable from the viewpoint of cost. Further, the internal electrode 3 may be plated on the surface. The terminal electrode 9 may be formed by the technique such as vapor deposition, pasting, printing or plating. After the terminal electrodes 9 have been formed on both end surfaces of each dielectric substrate 2, the dielectric substrates 2 may be layered. Otherwise, after the dielectric substrates 2 have been layered, the terminal electrodes may be formed on both end surfaces.

Now each of the layered dielectric substrate 1 constituting the mulitilayer capacitor 10 has the dents 7 or constrictions 4 so that the interval between the adjacent internal electrodes 3 is nonuniform and the maximum interval zones 5 are formed in the vicinity of the center in the lateral direction of the dielectric substrate 1. Thus, the balance between the voltage stress and the withstand voltage is optimized so that the multilayer capacitor 10 with the high withstand voltage can be realized.

By making the thickness of the layered dielectric substrate 1 layered in the vicinity of the center in the height direction (layered dielectric substrates 1 are layered) larger than that in the other region, the balance between the voltage stress and the withstand voltage can be optimized also in the height direction so that the multilayer capacitor 10 with the high withstand voltage can be realized.

By making the thickness of the dielectric substrate larger at the center in the height direction and also locating the maximum interval zone 5 between the adjacent internal electrodes 3 at the center in the lateral direction, the withstand voltage of the multilayer capacitor 10 can be further improved.

Finally, an explanation will be given of the a mold capacitor 20 formed by molding the multilayer capacitor 10 using a package 11.

FIG. 9 shows the mold capacitor 20 in which a pair of lead wires 12 are connected to the multilayer capacitor 10 and protrude from the package 11.

The lead wires 12 connected to the terminal electrodes 9 are employed for connection to a mounting board. In this case, the entire multilayer capacitor 10 and a part of the lead wires are covered with the package 11. Thus, the endurance of the multilayer capacitor 10 to external shock and environmental humidity can be further improved. Further, by extending the interval between the lead wires 12, the withstand voltage and the endurance against breakage can be improved.

The material of the package 11 may be epoxy resin such as opto-cresol-novolac series, biphenyl series or pentadiene series. The material other than these materials may be mixed, and further inexpensive resin may be used.

The minimum interval (thinnest portion of the package 11) between the surface of the package 11 and the surface of the multilayer capacitor 10 is set at 0.1 mm or more so that the withstand voltage of the outer surface can be improved. By setting the minimum interval at a value exceeding this value, the mold capacitor 20 resistant to stress, humidity and heat can be realized.

The shape of the package 11 may be a rectangular parallelepiped or cube. The corners of the package 11 each may be provided with a chamfer, arc or concave. The shape of the package 11 may be a trapezoidal pillar with any trapezoidal sides or elliptical pillar. The features of these shapes may be combined. By adopting these shapes, the shock resistance of the package 11 can be improved. Thus, the endurance of the mold capacitor 20 can also be improved. Accordingly, where the mold capacitor is mounted in the power source circuit or a signal line of the modem circuit, it can provide the high endurance.

A plurality of multilayer capacitors 10 may be sealed by the package 11. In this case, these capacitors can be simultaneously mounted in a two-wire signal line.

FIG. 9 is a perspective view of the mold capacitor 20. The internal structure of the mold capacitor 20 is illustrated with a part of the package 11 indicated by broken line. The mold capacitor 20 includes two multilayer capacitors 10 covered with the package 11. Each multilayer capacitor 10 is provided with a pair of terminal electrodes 9 which are connected to lead wires 12, respectively. Namely, four lead wires 12 protrude from the package 11.

As described above, by making the interval between the adjacent internal electrodes 3 nonuniform and particularly locating the maximum interval zone at the center in the lateral direction of the dielectric substrate 2, the balance between the voltage stress and withstand voltage can be optimized. Thus, the dielectric substrate with an excellent withstand voltage can be realized without hindering its downsizing. As a result, the multilayer capacitor and mold capacitor with the excellent withstand voltage can be realized with the size being reduced.

Particularly, in the multilayer capacitor having the same size, its withstand voltage can be kept at a sufficiently high value.

Referring to FIG. 10, an explanation will be given of the relationship between the serge breakage voltage and capacitance in the case where this invention is applied to the multilayer capacitor 10. It is assumed that the multilayer capacitor 10 has 8 poles, 36 layers of the effective electrodes, an interval of 30 μm between the opposite internal electrodes (in the thickness direction of the multilayer capacitor), a dielectric constant of 2400, an F dimension of 0.125 to 0.2 mm (FIG. 10), a W dimension of 0.075 to 0.150 mm (FIG. 10).

The E center shown in FIG. 10 indicates the interval between the adjacent internal electrodes 3 at the center of the outer edges 30 thereof. In FIG. 10, Emin indicates the minimum interval between the internal electrodes 3 over the outer edges 30 thereof. In FIG. 10, the horizontal axis represents Ecenter/Emin and the vertical axis represents the serge breakage voltage (kVp-p) and capacitance (pF). As seen from the graph of FIG. 10, the serge breakage voltage decreases as the Ecenter/Emin increases (i.e. the degree of constriction increases) and the capacitance increases as the Ecenter/Emin decreases (i.e. the degree of constriction decreases).

### Embodiment 2

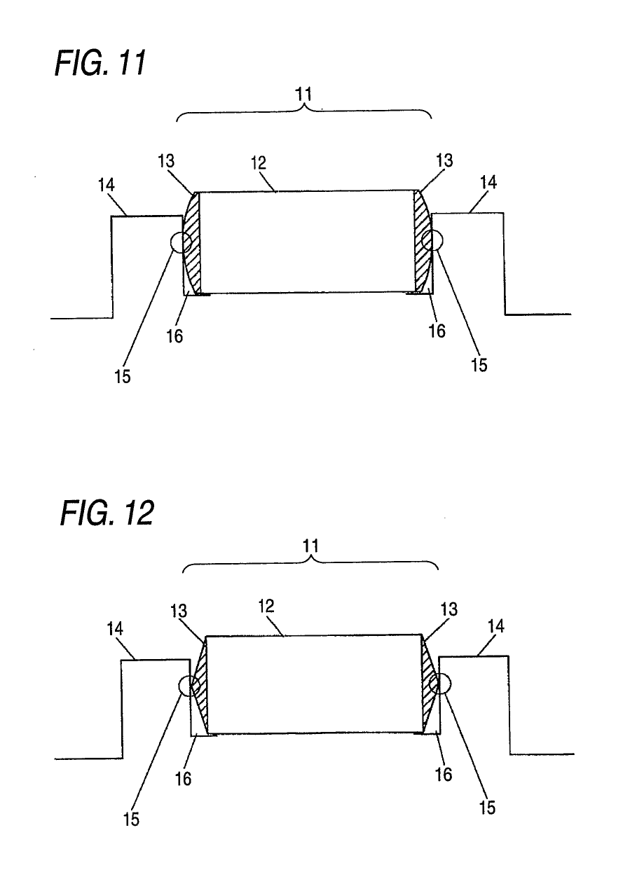

FIGS. 11 to 19 are a side view of the multilayer capacitor according to the second embodiment of this invention, respectively.

In these figures, reference numeral 11 denotes a multilayer capacitor; 12 a substrate; 13 a terminal electrode; 14 denotes a lead wire; 15 a contact region; 16 a filling space; 17 an internal electrode; and 18 a package.

First, a detailed explanation will be given of each component.

First, the substrate 12 will be explained.

The substrate 12 is a substrate of a dielectric material, which is preferably e.g. titanium oxide or barium titanate. The dielectric material may be alumina. According to the desired dielectric constant (the value of capacitance can be adjusted by the dielectric constant) and material strength of these oxide-series dielectric material, metallic dielectric material and ceramic-series dielectric material, the material and its composition ratio is selected appropriately.

Further, these materials are mixed with an organic material, as required, to be molded into any shape, and heat-treated, as required, to be formed into a substrate shape.

The dielectric substrate 12 is formed in a size and shape corresponding to those of the multilayer capacitor 10. For example, the substrate 12 may be formed of a box- or a plate-shape having a desired thickness, a film-like sheet or the plate in the other shape than the rectangle. Where the substrates 12 are layered, each substrate 12 is preferably a film-like sheet. In this case, the substrates 12 may have different thicknesses. According to the level of the voltage stress, the substrates 12 may be layered at different positions and with different thicknesses. For example, in the vicinity of the center where greater voltage stress is applied, preferably, the substrate 12 which is thicker is located. Further, according to the difference among the levels of the applied voltage stress, the thicknesses of the substrates 12 may be gradually changed.

Next, the terminal electrode 13 will be explained.

The terminal electrodes 13 may be provided as a pair on both end surfaces of the substrate 2, but may be provided on the upper and lower sides.

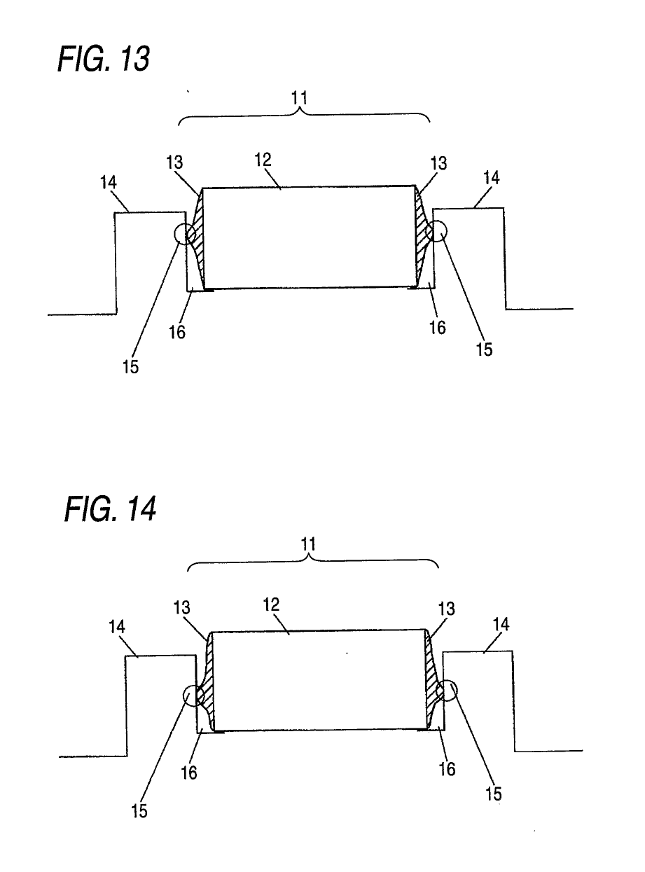

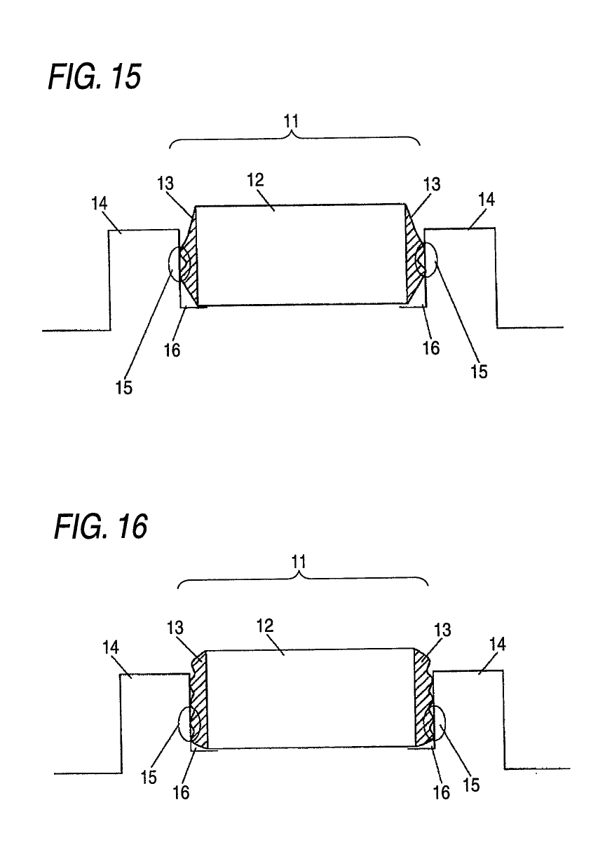

The terminal electrode 13 is non-planar in the shape of its surface as seen from FIGS. 11 to 16. Specifically, in FIG. 11, the terminal electrode 13 is arc-shaped. In FIG. 12, the terminal 13 is hill-shaped. In FIGS. 13 and 14, the terminal electrode 13 is convex-shaped. In FIG. 15, the terminal electrode 13 is formed in a shape of a plurality of convexes. In FIG. 16, the terminal electrode 13 is wavy-shaped.

In this way, the non-planar shape of the terminal electrode 13 is realized by the shape of the arc, hill, convex 40 or wave.

The convex 40 may be formed in singularity or plurality.

Where a single convex 40 is formed (FIG. 13), the contact region 15 is defined at a single position so that the point contact can be easily assured. Where a plurality of convexes 40 (FIG. 15) are formed, the total area of contact region can be extended.

Further, the convex 40 may be formed on the surface of the terminal electrode 13 over the entire region in the width direction thereof, or only at a part in the width direction In the former case, the contact area between the terminal electrode 13 and the lead wire 14 can be extended, and in the latter case, the point contact region 15 can be surely formed.

The convex 40 may be formed at a position near the bottom, a nearly central position or at a position near the top in the vertical direction.

Where the convex 40 is formed at the position near the bottom, the bending degree of the lead wire 14 connected can be decreased, thereby reducing the material cost of the lead wires 14. Where the convex 40 is formed at the nearly central position, the supporting balance of the substrate 12 by the lead wires 14 and the balance between an applied voltage and a voltage stress can be optimized. Where the convex 40 is formed at the position near the top, the supporting force of the substrate 12 by the lead wires 14 can be improved.

The terminal electrode 13 may be made of the metallic material or alloy containing at least one of Ni, Ag, Pd, Cu and Au. Particularly, using elemental Ni or Ni alloy is preferable from the viewpoint of cost. Further, the terminal electrode 13 may be plated on the surface.

The terminal electrodes 13 can be formed by paste-application, plating, vapor deposition or sputtering using the above material.

The lead wires 14 will be explained.

The lead wires 14 are connected to the terminal electrodes 13, respectively. The lead wires 14 serve to support the substrate 2, thus permitting the multilayer capacitor to be surface-mounted.

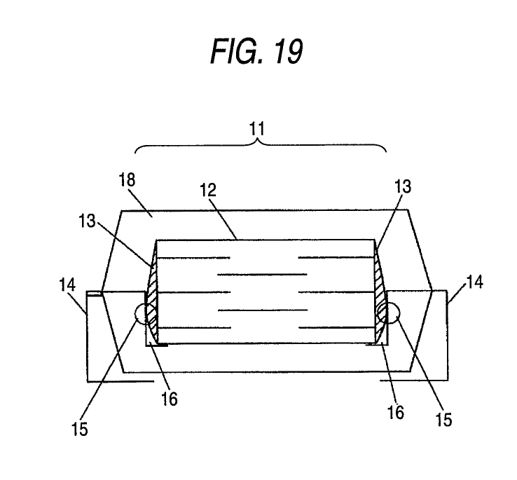

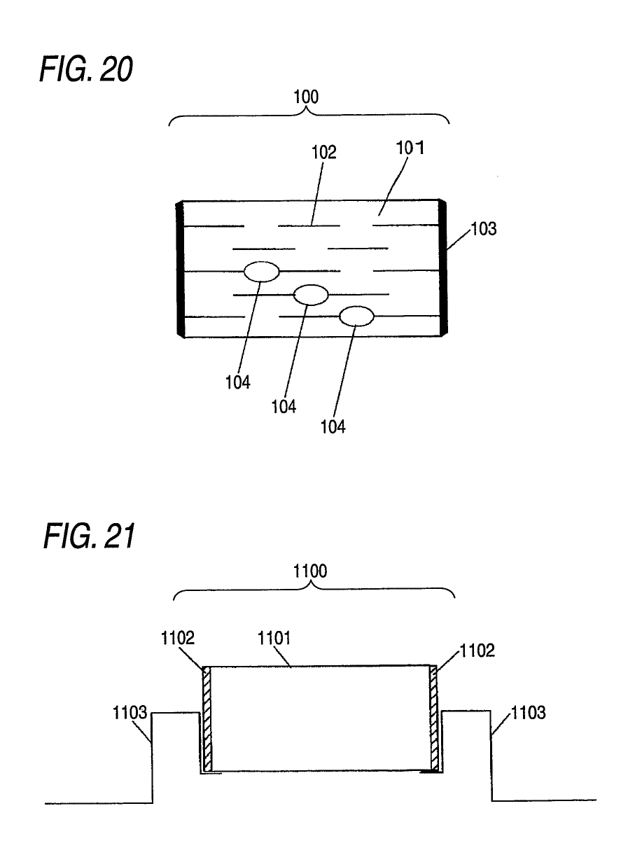

By bending the lead wires 14 as shown in FIG. 11, they are connected to the terminal electrodes 13 and can assure the mounting surface for a mounting board. Namely, as shown in FIG. 11, by forming the bent area of the lead wires 14 to reach the bottom, the substrate 12 can be surely supported. Further, the lead wires 14 may be bent outwardly (FIG. 11) or inwardly (gull-wing type) (FIG. 19). In the former case, the creepage interval can be increased to improve the withstand voltage, and the mounting strength can be increased. In the latter case, the mounting area can be reduced.

The contact regions 15 will be explained.

The contact region 15 is a region where the terminal electrode 13 and the lead wire 14 are kept in physical contact with each other with no gap. At the contact region 15, the terminal 13 and the lead wire 14 are in contact with each other by sufficient contact force so that the electric contact therebetween can be sufficiently assured. Where the terminal electrode 13 is formed in the arc shape as shown in FIG. 11, at its tip or top, it makes with a point contact with the lead wire 14. Therefore, the contact region 15 for point contact can be formed regardless of the angle or placing manner when the terminal electrode 13 is received by the lead wire 14.

Likewise, in the cases where the terminal electrode 13 is hill-shaped (FIG. 12) and convex-shaped (FIGS. 13 and 14), the contact region IS can be surely formed between the lead terminal 14 and the terminal electrode 13 regardless of the above angle and placing manner.

Even if the angle or shape is displaced when the lead wires 14 are fit to the terminal electrodes 13, the contact region 15 can surely make the point contact, thereby permitting the electric connection to be assured.

On the other hand, in a conventional multilayer capacitor as shown in FIG. 21, the surface of the terminal electrode 1102 is nearly planar so that in its connection to the lead wire 1103 which is also planar, a displacement of the angle occurs, thereby making it impossible to assure the contact region. Particularly, since the lead wire 1103 is mechanically bent, a roundness occurs in the bent area. Therefore, the connection between the lead wire and terminal electrode both of which have a flat plane cannot make a sufficient electric connection at the contact region.

On the contrary, according to the present invention as described above, by making the surface of the terminal electrode 13 non-planar, even when the lead terminal 14 has a flat plane, or the roundness occurs in the bent area, the contact region 15 by the point contact can be assured, thereby assuring the sufficient electrical connection.

Thus, the sufficient strength of the electrical connection can be assured.

The filling spaces 16 will be explained.

Where the terminal electrode 13 is arc-shaped as shown in FIG. 11, by the bent lead wire 14, the filling space 16 can be formed in the vicinity of the bottom received by the bent lead wire 14 and above the contact region 15. The filling space 16 is filled with fixing agent, e.g. solder for connection between the lead wire 14 and the terminal electrode 13.

Thus, while the contact region 15 where the terminal electrode 13 and lead wire 14 are in direct contact with each other is assured, the filling space 16 of the filling agent capable of assuring the physical connection is also assured around the contact region 15 so that the filling agent such as solder spreads sufficiently. In this way, while electrical connection strength can be assured by the contact region 15, the physical connection strength can be assured by the filling agent filled in the surrounding filling space 16.

As described above, in accordance with this embodiment, the arc, hill, wave or convex 40 is formed on the surface of the terminal electrode 13 so as to make the surface of the terminal electrode 13 non-planar, thereby assuring the contact region 15 between the terminal electrode 13 and the lead wire 14. In addition, the filling agent such as solder is filled around the contact region 15. Thus, both the electric connection strength and the physical connection strength can be simultaneously assured. Even if there is a slight change in the angle of the lead wire 14 or slight deformation of the shape of the lead wire 14, the contact region 15 and filling space 16 can be assured so that the electric connection strength and the physical connection strength can be improved at a very high yield. Further, no poor contact at the connecting portion occurs so that the withstand voltage and endurance of the multilayer capacitor can be also improved. Particularly, since the completed multilayer capacitor can cope with the stress in input/output of the signal current in a long time use, the endurance thereof can be improved in the long time use.

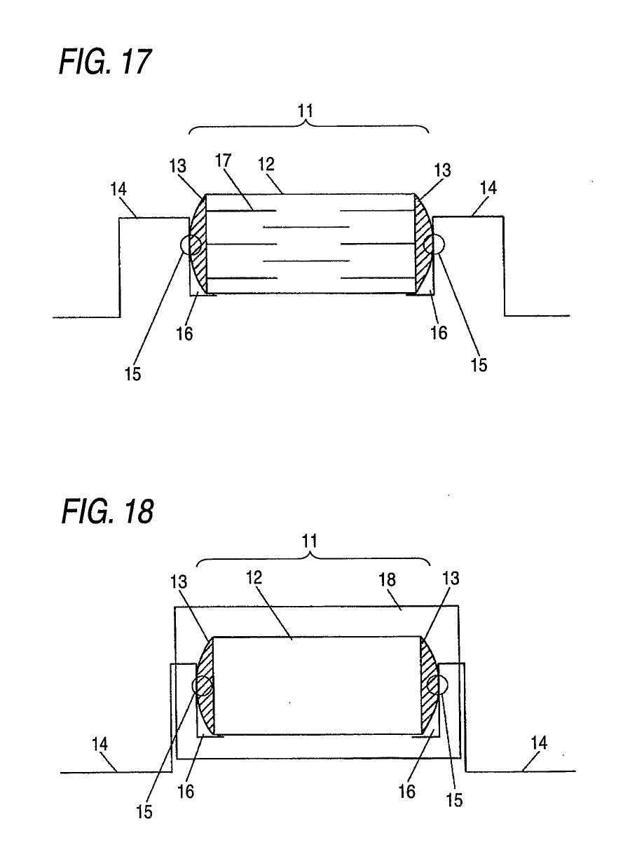

This applies to both cases where a single substrate 12 is layered (FIG. 11) and a plurality of substrates 12 are layered as shown in FIG. 17.

In the case of the multilayer capacitor, the high capacitance can be realized and hence the high withstand voltage is demanded. In such a case also, in accordance with the multilayer capacitor according to this embodiment, both sufficient electrical connection strength and physical connection strength can be assured so that in the multilayer capacitor for which the high capacitance is demanded, a required withstand voltage and endurance can be assured.

The multilayer capacitor is preferably covered with a package 18 as shown in FIGS. 18 and 19. By covering the entire substrate 12 and a part of the lead wires 14 with the package 18, the humidity resistance and the shock resistance can be improved so that the endurance of the multilayer capacitor can be further improved.

The material of the package 18 may be preferably epoxy resin such as opto-cresol-novolac series, biphenyl series or pentadiene series. The material other than these materials may be mixed, and further inexpensive resin may be used.

The minimum interval (thinnest portion of the package 18) between the surface of the package 18 and the surface of the multilayer capacitor 10 is set at 0.1 mm or more so that the withstand voltage of the outer surface can be improved. By setting the minimum interval at a value exceeding this value, the mold capacitor 20 resistant to stress, humidity and heat can be realized.

The shape of the package 18 may be a rectangular parallelepiped or cube. The corners of the package 18 may be provided with a chamfer, arc or concave. The shape of the package 18 may be a trapezoidal pillar with any trapezoidal sides or elliptical pillar. The features of these shapes may be combined. By adopting these shapes, the shock resistance of the package 18 can be improved. Thus, the endurance of the multilayer capacitor 1 can also be improved. Accordingly, where the multilayer capacitor is mounted in the power source circuit or a signal line of the modem circuit, it can provide the high endurance.

Where the multilayer capacitor is covered with the package 18, it is preferable that the lead wires 14 are protruded from the sides of the package 18 and plays are formed between the lead wires 14 and the package 18, thereby improving the warping capability. It is also preferable that the lead wires 14 are protruded from the bottom of the package 18, thereby improving the warping capability.

As described above, since the surface of the terminal electrode 13 is formed in the arc-shape, hill-shape, convex shape or wavy shape, its connection with the lead wire 14 can be assured at a high yield and the filling space 16 is sufficiently filled with the filing agent such as solder. In accordance with such a configuration, in the connection between the terminal electrode 13 and the lead wire 14, both electrical connection strength and physical connection strength can be improved, thereby providing the multilayer capacitor with excellent withstand voltage and endurance:

An explanation will be given of a method for manufacturing a mold capacitor. First, a main raw material (e.g. barium titanate) is doped with an additive and baked to create a pulverulent body. The pulverulent body thus created is doped with the solvent, plasticizer and binder to create slurry. Using the slurry, a dielectric sheet, i.e. dielectric substrate 12 having a prescribed thickness is made. Internal electrodes 17 are pattern-printed on the dielectric substrate 12. A plurality of dielectric substrates 12 on each of which the internal electrodes 17 are printed are layered, and cut in a chip shape. Thus, the multilayer capacitor is completed.

The multilayer capacitor 11 thus completed is baked to vaporize the plasticizer and hardened. After hardened, the multilayer capacitor 11 is barrel-polished and chamfered. The terminal electrodes 13 are applied to the multilayer capacitor 11 chamfered and baked. The lead wires 14 are soldered to the terminal electrodes 13 baked. A part of the lead wires 14 and the multilayer capacitor 11 are molded by the package 18. The lead wires 14 protruded outwardly are plated and further bent.

This application is based upon and claims the benefit of priorities of Japanese Patent Application No. 2004-279070 filed on Sep. 27, 2004 and 2004-281829 filed on Sep. 28, 2004, the contents of which are incorporated herein by reference in its entirety.

### INDUSTRIAL APPLICABILITY

This invention is to provide a multilayer capacitor and mold capacitor which can realize a high withstand voltage without hindering downsizing and implementation of high capacitance.

1. A mulitilayer capacitor comprising
a plurality of dielectric substrates which are layered;
a pair of terminal electrodes formed on the plurality of dielectric substrates; and
a plurality of internal electrodes arranged on each of the dielectric substrates and having outer edges opposed apart by a predetermined interval,
wherein at least one of said internal electrodes is arranged apart from an adjacent internal electrode by the maximum interval at the center of the outer edges.

2. A multilayer capacitor according to claim 1, wherein at least one of said internal electrodes is arranged apart from the adjacent internal electrode by the minimum interval at at least one end of the outer edges.

3. A multilayer capacitor according to claim 2, wherein at least one of said internal electrodes is arranged apart from the adjacent internal electrode by the minimum interval at both ends of the outer edges.

4. A multilayer capacitor according to claim 1, wherein at least one of said internal electrodes and the adjacent internal electrode have the outer edges which are constricted.

5. A multilayer capacitor according to claim 1, wherein said plurality of internal electrodes are transfer-printed on each of said dielectric substrates.

6. A multilayer capacitor according to claim 1, wherein the number of said plurality of dielectric substrates is three or more, and
the dielectric substrate layered inside said multilayer capacitor is thicker than the dielectric substrates layered on both ends of said multilayer capacitor.

7. A multilayer capacitor according to claim 1, wherein the thickness of said plurality of dielectric substrate becomes larger toward the center in a layering direction thereof.

8. A mold capacitor comprising:
a mulitilayer capacitor according to claim 1,
a pair of lead wires connected to said pair of terminal electrodes, respectively, and
a package covering a part of said pair of lead wires and said multilayer capacitor.

9. A mold capacitor according to claim 8, wherein at least one of said pair of terminal electrodes is formed in a non-planar shape, and
said terminal electrode formed in the non-planar shape is kept in point contact with one of said lead pair of lead wires at at least one contact region.

10. A mold capacitor according to claim 8, wherein at least one of said pair of terminal electrodes is formed in an arc shape.

11. A mold capacitor according to claim 8, wherein said arc shape is created utilizing surface tension when said pair of terminal electrodes are formed.

12. A mold capacitor according to claim 8, wherein at least one of said pair of terminal electrodes is provided with a convex.

13. A mold capacitor according to claim 12, wherein said convex is formed in plurality on at least one of said pair of terminal electrodes.

14. A mold capacitor according to claim 8, wherein at least one of said pair of terminal electrodes is formed in a wavy shape.

15. A mold capacitor comprising:
a plurality of dielectric substrates which are layered;
a pair of terminal electrodes formed on the plurality of dielectric substrates;
a pair of lead wires connected to said pair of terminal electrodes, respectively; and
a package covering said plurality of dielectric substrates, said pair of terminal electrodes and a part of said pair of lead wires, wherein
at least one of terminal electrodes is formed in a non-planar shape, and
said terminal electrode formed in the non-planar shape is kept in point contact with one of said lead pair of lead wires at at least one contact region.
